(19) United States
(12) Patent Application Publication
(10) Pub. No.: US 2010/0125505 A1
(43) Pub. Date: May 20, 2010

(54) SYSTEM FOR BROADCAST OF PERSONALIZED CONTENT

(75) Inventor: Hemanth Puttaswamy, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: COREMETRICS, INC., San Mateo, CA (US)

(21) Appl. No.: 12/272,669

(22) Filed: Nov. 17, 2008

(51) Int. Cl. G06Q 30/00; G06Q 90/00

(52) U.S. Cl. 705/14.67

(57) ABSTRACT

The present invention relates to a system and method that allows an advertising content network to be notified when a user visiting web sites has satisfied some behavioral targeting criteria. The advertising network can use this information to provide an advertisement directly targeted to the criteria that has been satisfied.

### CROSS-REFERENCES TO RELATED APPLICATIONS

NOT APPLICABLE

### BACKGROUND

The present invention relates to providing a targeted advertisement to an internet user, and in particular to notifying an advertising content network about an internet user's online behavior in order for the advertising content network to provide the most suitable advertisement.

There are a large number of web sites that generate revenue by selling advertising “space” on their web pages. A typical example is the web site of a newspaper, such as the web site provided by the Washington Post at www.washingtonpost.com. An internet user visiting that site will be presented with advertisements for any number of products and services. The advertisement can be a “Banner Ad” displayed at the top of the page or an advertisement may be placed anywhere on a web page, as desired by the web site owner.

In one method of selling advertisement space to advertisers, the web site owner may directly contract with the entity wishing to advertise a product or service. The web site owner may sell the advertiser space on their web pages to display advertisements. In some cases, the advertisements may be provided to the web site owner in a static form for inclusion into the web page. In other cases, the advertiser will be allowed to place a link in the web page to retrieve advertising content. The content can be changed by the advertiser at will.

This mode of operation has the disadvantage that the web site owner will typically not be able to sell all the advertising space available to a single advertiser. The web site owner may be forced to maintain a sales department to market and sell advertisement space. The additional overhead of maintaining such a department can be significant. Many web site owners would prefer to be able to sell the advertising space in a wholesale manner, without having to individually contract with advertisers.

In response to this desire, there are many advertising content networks that have been created. An advertising content network may purchase web display space in bulk from a web site owner. The advertising content network can then place advertisements of its choosing within that space. In turn, the advertising content network resells this advertising space to those wishing to advertise. One way of selling this advertising space is by charging an advertiser a flat rate for every time the advertisement is placed on a web page, which is sometimes referred to as an impression. Per impression advertising is generally sold in units of one thousand such that an advertiser will pay a fixed CPM (Cost per Thousand) amount for every one thousand times his ad is viewed. There is no guarantee that the end user will pay any attention to the advertisement.

Most web advertisements, in addition to containing advertising content, are also linked to further information. An end user who views an advertisement on a web page can typically click on the advertisement and be taken to another web site that may feature additional details on the product or service that was being advertised, with further information on how to purchase that product or service. Advertisers are very interested in this type of user because they have expressed an explicit interest, by clicking on the advertisement, in the product or service that is being advertised. Because this type of user is so valuable to the advertiser, they typically may contract with the advertising content network to pay a certain amount for every end user that clicks on an advertisement. Such pricing is sometimes referred to as “click thru pricing” or CPA (Cost per Action) The advertising content network will receive compensation for every end user that clicks on an advertisement. The compensation received for click thru advertising (CPA) is generally much larger than that received for per impression (CPM) advertising.

The advertising content network benefits by providing advertisements to end users that are tailored to the interests or needs of each specific end user. An advertisement specifically targeted to a specific end user's needs has a greater chance of being clicked on by the end user, thus increasing the advertising content networks' revenue. Systems have been created to help improve the ability of an advertising content network to target the desires of end users. One such example is a system as described in U.S. Pat. No. 5,933,811 entitled System and Method for Delivering Customized Advertising Within Interactive Communications Systems assigned to Paul D. Angles. In the system as described therein, an end user can register with an advertising content network and select the types of advertising that the end user would desire. The advertising content network can then provide advertisements based on the user's preferences.

As should be clear, a static, voluntary registration program such as this suffers from many shortcomings. First, it relies on the end user's desire to “opt in” to the system by registering and providing preferences and identification information to the advertising content network. Second, it relies on the accuracy of the end user's selected preferences. Finally, being largely static information, it does not take into account the real time preferences of the users for goods or services they may desire at that specific moment.

As such, it would be desirable for an advertising content network to have as much real time information about an internet end user as possible in order to display to the user an advertisement that is the most relevant to the end user's current needs. An advertising content network would desire to be able to identify an end user, their current internet and non internet activities, and even their historical activities, in order to display the most relevant ad. An ad targeted to a specific user has a much higher likelihood of being clicked by the user and would be beneficial to both the user and the revenues of the advertising content network. Such a system should not require an end user to opt in to the system, and should be as transparent to the end user as possible.

In addition to, or in many cases instead of generating revenue by selling advertisements, many web sites generate revenue by selling products or services. A typical example of such a web site would be one provided by a department store, such as Macy's, found at www.macys.com. On such a web site it is possible for an end user to browse through the various items being offered for sale, select items for purchase, and potentially purchase the items. Operators of such web sites have a desire to track the behavior of visitors to the web site to improve sales. For example, if a large number of users browse the web site, select items for purchase, then abandon the transaction during the payment phase, this may indicate that the payment phase is flawed. The payment process may be overly cumbersome, causing users to become frustrated and abandon the items they wished to purchase.

A web site owner may wish to track how the users of the site browse, select, and purchase items, to help increase sales. For example, by reviewing the data, the web site owner may be able to determine that if more than a certain number of clicks are required to locate a product of interest, users may tend to give up before finding the item and potentially purchase it.

In order to address the need to track users and their behavior on a web site, an entire field referred to as Web Analytics has developed. The field is directed to monitoring a user's behavior on a web site and aggregating that behavior with the behavior of other users to determine trends. By inspecting this data, web site owners may tailor their web sites to respond to the trends.

One example of such a Web Analytics system is described in U.S. Pat. No. 7,050,989 entitled Electronic Commerce Personalized Content Delivery System and Method of Operation assigned to the owner of the present application. In the system described therein, an web site owner can embed “tags” in their web pages. These tags may contain executable code, such as Javascript, that will cause a computer viewing the page to send a query to a data aggregation server. This query allows the data aggregation server to place identifying information about the user in a cookie placed on the user's computer. The data aggregation server can further use additional cookies to identify activities of the user during a given internet usage session. Each time a user views a new page within the web site, a new query may be sent, and the activities of the user within the web site can be tracked.

The data from the data aggregation server can be sent to a database. There the data can be combined with data from other users to monitor trends amongst all the users on a given web site. Furthermore, if the data aggregation server services more than one web site, data between the web sites can be compared. For example, data collected from all the users of a department store web site may indicate that if more than three clicks are needed from the start to end of the payment process, the users tend to abandon the transaction. Data from another department store web site may indicate the same thing. From this data, a conclusion may be made that users who shop at department store web sites tend to abandon purchases if more than three clicks are required to complete a transaction.

Furthermore, the data for individual user's behaviors across time may be stored to determine trends. For example, it is possible to track the number of times a user comes to a web site, and if the user makes a purchase. By aggregating this user's data with the data of all other users, it may be possible to determine trends. For example, among users who visited the web site more than three times in a one month period, more than half of them make a purchase.

There have been other attempts at delivering targeted advertisements to users based on their web usage profile. An example of such a system is described in several patent applications assigned to Yahoo. (application Ser. Nos. 11/394,332, 11/394,343, 11/394,353, 11/394,358, and 11/394,374). The systems as described therein generate long and short term profiles of a user based on the user's internet usage. Analyzing this data allows the system to generate a profile score, which may be indicative of the type of content or advertising the user may be interested in. Based on this, the system can deliver a more targeted advertisement. Such a system however does not allow an advertisement content network to specify a specific internet behavior of interest. Furthermore, it does not provide for an advertisement content network to be notified when that specific behavior has occurred.

Other systems that attempt to use an internet user's profile to deliver targeted content have also been created. Some examples of these systems are described in U.S. patent application Ser. No. 11/763,286 assigned to Almondnet, Inc. and application Ser. No. 11/693,719 assigned to NEBUAD, Inc. Similarly to the Yahoo applications, the systems described in these applications attempt to generate a user profile based on user internet usage, and deliver advertisements based on that profile. They do not allow an advertisement content network to specify a specific internet behavior of interest. They also do not allow an advertisement content network to be notified when that specific behavior has occurred.

As has been described above, there are advertising content networks that would desire to know about a user's current and historical activities in order to provide the most suitable advertisements. There are also web analytics systems that track user's behavior on and across web sites. It would be advantageous to provide a system and method to allow a advertising content network to provide information to a web analytics system to request information about users who meet certain criteria. Using data stored for the web analytics process, the advertising content network can be notified when a user has met the criteria. If the user then visits a web site that displays ads from the advertising content network, the network can make a better decision as to which ad to display. Such a system should require no active participation by the user. Furthermore, such a system should also provide the user with the ability to opt out of the system.

Embodiments of the present invention address the situation above and other situations, individually and collectively.

### BRIEF SUMMARY

The present invention relates to a system and method that allows an advertising content network to be notified when a user visiting web sites has satisfied some behavioral targeting criteria. The advertising network can use this information to provide an advertisement directly targeted to the criteria that has been satisfied.

In one embodiment of the invention, an advertising content network defines a behavioral targeting rule. The behavioral targeting rule can contain conditions to be satisfied prior to sending a notification to the advertising content network. The rule can be sent to a database that stores the rules.

A web analytics system can embed computer code on a variety of web pages on web sites. The query contains code that instructs the computer of a user visiting the web page to send a query to the web analytics system. The query can contain information that identifies the web page being visited. The information received can also be stored in a profile database for later use.

In addition, the web analytics server can store a session cookie on the user's computer. The session cookie can contain a session identifier that allows the web analytics system to group all the queries received by this user into a single web usage session.

In addition to the code that sends queries, computer code can be inserted onto web pages that instructs the user's computer to exchange an identifier with an advertisement content network. The identifier can be received and stored in the session cookie. In addition, the advertisement content network can also store another cookie on the user's computer that contains this same identifier.

The information identifying the web page that is being visited can be compared with the behavioral targeting rules to determine if the condition specified in a rule has been satisfied. If a rule has been satisfied, a notification can be sent to the advertising content network. The notification can include the identifier that was previously provided by the advertising content network, as well as an indication of which behavioral targeting rule has been satisfied. The advertising content network can use this information to provide an advertisement to a user that is targeted to that individual user.

### BRIEF DESCRIPTION OF THE DRAWINGS

FIG. 1(A) is a block diagram of a system for broadcast of personalized content according to an embodiment of the invention.

FIG. 1(B) is a block diagram of a system for broadcast of personalized content according to another embodiment of the invention.

FIG. 2 is a block diagram illustrating an exemplary embodiment of advertisement content network user identification exchange of the present invention.

FIG. 3 is a block diagram illustrating an advertising content network using the system to deliver a targeted advertisement.

FIG. 4 is a flow chart the describes the operation of the broadcast system for personalized content.

FIG. 5 is a flow chart the describes the operation of the advertisement content network using a behavioral targeting rule to deliver a targeted advertisement.

FIG. 6 is a block diagram of an apparatus for use in the present invention.

### DETAILED DESCRIPTION

Overall System

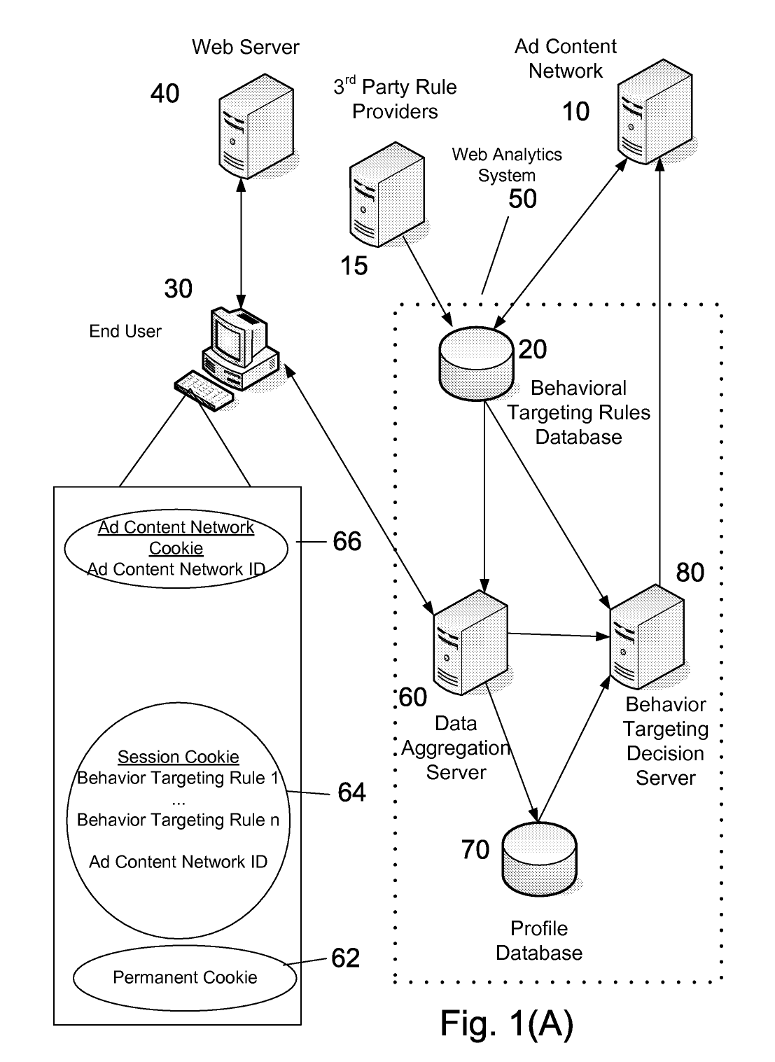

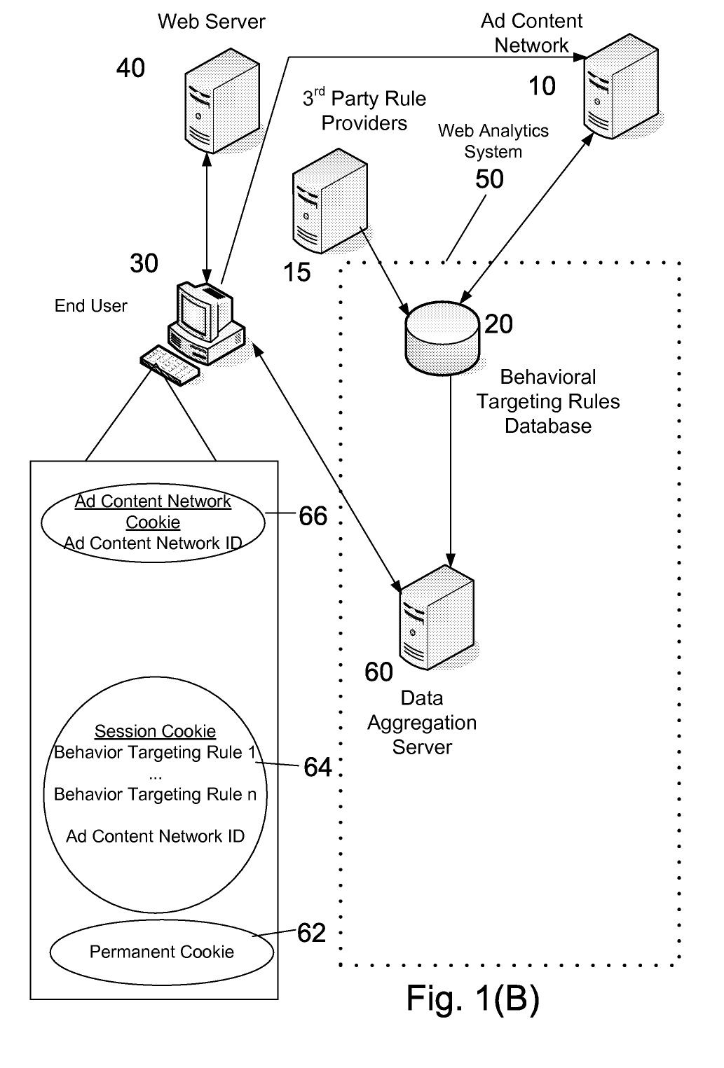

FIG. 1(A) is a block diagram of a broadcast system for personalized content according to an embodiment of the present invention. An advertisement content network server 10 provides behavioral targeting rules to a behavior targeting rules database 20. Behavioral targeting rules describe the conditions for which the advertisement content network server 10 desires to be notified. One example of such a rule is a desire to be notified of users who are currently browsing the internet for a specific item, such as a leather jacket. Another example may be a desire to be notified of users who have visited high end consumer electronic web sites more than three times in the last month. A rule can be defined for any type of behavior that the advertisement content network server 10 wishes to be notified of.

Another example of behavioral targeting rules that the ad content networks 10 may wish to be notified of includes rules that are dynamic and based on industry benchmarks. For example, by looking at historical data, such as data that may be stored in a profile database 70, it may be possible to determine that within an industry, such as the apparel industry, users who conduct more than three on site natural language searches end up purchasing a product more than 50% of the time. An ad content network may wish to be notified every time a user meets this criteria. Rules based on dynamic industry benchmarks that are provided by either the web analytics system itself or by external sources can be used to provide notifications to ad content networks.

In addition to rules that are set by ad content networks 10, behavioral targeting rules may also be set by any number of 3rd parties 15. In some embodiments, the rules may be set by the parties that are actually producing the advertising content. For example, a department store that sells a certain brand of shoes may set a rule that requires the ad content network 10 to be notified whenever a user views web pages associated with the brand of shoes. As such, the ad content network can be notified that the user has been looking for the particular brand of shoes. The rule can cause the ad content network to deliver an ad, supplied by the department store, for the particular brand of shoes if the user is seen in the future.

In some embodiments there may be many 3rd party rule providers. For example, each client of the web analytics system 50 may define their own rules for behavioral targeting and the rules database 20 will maintain different sets of rules on a per client basis. In some cases, the rules may specify that historical data from users of the web sites of different clients may or may not be commingled. For example, if the web analytics system 50 has two department store clients, the rules can be specified such that the data collected from each of the client's web sites may not be commingled for purposes of rule analysis. Alternatively, if there is an agreement between the clients, rules can be specified such that the data across all the clients may be aggregated. Sharing and aggregation of data across multiple clients of the web analytics system for use in rule analysis is entirely based on agreements between the clients, advertisement producers, and ad content networks. The behavioral targeting system neither requires nor prohibits such data sharing.

Although FIG. 1(A) has depicted ad content network 10 as a single entity, embodiments of the present invention are not limited to a single ad content network. For example, the web analytics server may maintain relationships with many different ad content networks. In addition, the relationships between the ad content networks may be segregated based on the clients of the web analytics system. Furthermore, the ad content networks themselves may not be a single entity, but rather a network of ad content networks and ad content providers. For example, an ad content network may purchase advertising space on a CPM or CPA basis. That content network may further resell this advertising space to other advertising content networks, or to advertisement content producers themselves. The advertisement content networks may further use any number of advertising delivery technologies to deliver the web advertisements. Ad content network 10 is a simplification of any number of entities that wish to define rules for behaviors they wish to be notified of. In some cases, ad content network 10 may not deliver any advertisements, but rather is itself a behavioral targeting service which desires additional behavior information.

The advertisement content network server 10 or 3rd party rule providers 15 may provide the behavioral targeting rules to the behavior targeting rules database 20 through any number of interfaces. One example of such an interface is an Application Programming Interface (API) provided by the behavior targeting rules database 20 to allow a direct computer to computer interface between the advertisement content network server 10 or the or 3rd party rule providers 15 and the rules database 20. Another interface can be a user interface that will allow a human operator to manually insert rules into the rules database 20.

An end user 30 may visit any number of web servers 40 to view web pages. The end user 30 sends a request for a web page to a web server 40, which can respond by providing the web page containing the content the user 30 has requested. In addition to providing content, the web server 40 may also be associated with a web analytics system 50 to allow the owner of the web server 40 to track usage of the web site. The web server 40 can embed computer code, such as Javascript, that is provided by the web analytics system 50 into the web pages that are delivered to the end user 30. This embedded code can be referred to as a tag.

Once received by the end user computer 30, the embedded tag can instruct the end user computer 30 to send a query to a data aggregation server 60 which is part of the web analytics system 50. The query can include information about the web page that is currently being viewed, such as the owner of the web site or the product that is being viewed. In addition, the query can include information in a permanent cookie 62 and a session cookie 64 if those cookies have been previously stored by the data aggregation server 60 on the end user computer 30. The permanent cookie 62 can contain information that allows the data aggregation server 60 to identify an individual end user's computer 30. The session cookie 64 can contain data that allows the data aggregation server 60 to determine the internet activities of the end user 30 for a particular browsing session. A session length may be defined by the data aggregation server 60 to be some period of time, such as a single day. Additional periods of time or criteria are also possible.

If no permanent cookie 62 exists on the end user's computer 30, the data aggregation server 60 can create a new permanent identifier for this end user, and store the information in a permanent cookie 62 on the end user's computer 30. Likewise, if no session cookie 64 exists on the end user computer 30 because it has either never existed or has expired, the data aggregation server 60 can write a session cookie to the end user's computer 30. The data aggregation server 60 can store information about the start time of the session, when the session will expire, and other information in the session cookie 64. In addition, the data aggregation server 60 can retrieve behavioral targeting rules from the behavior targeting rules database 20 and store those rules in the session cookie 64. In order to efficiently use the space available in the session cookie 64, the rules may be compressed and encoded to increase storage efficiency. In some embodiments, the rules stored in the session cookie will be evaluated on the end user's computer as described in FIG. 1(B).

In addition to storing and/or updating cookies on the end user computer 30, the data aggregation server 60 can additionally log the query received from end user computer 30 into a profile database 70. The information contained in the query, such as the web site visited, or product viewed, along with the information in permanent and session cookies 62, 64, can be used to establish internet browsing behavior for an individual user over periods of time. In addition, the information from many different end users can be aggregated to determine trends among end users. Other servers (not shown) in the web analytics system 50 can be used to process this data, and provide reports regarding web usage to the owners of web sites.

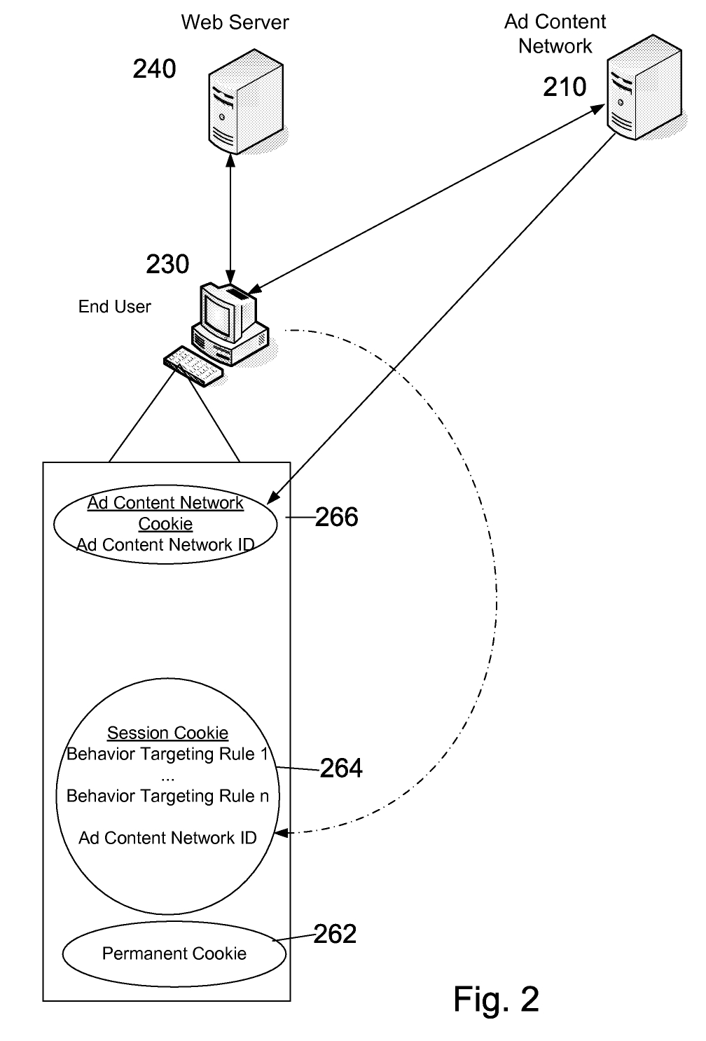

A behavior targeting decision server 80 can analyze the information received in the query, and in some embodiments, the historical information stored in the profile database 70, to determine if an end user 30 has satisfied a behavioral targeting rule stored in the behavioral targeting rules database 20. If so, the behavior targeting decision server 80 can send a message to the advertising content network server 10 that defined the rule to notify it that an end user 30 has satisfied the rule. The message can contain an identifier associated with a cookie 66 placed on the user's computer by the advertisement content network server 10 and stored in the session cookie 64 sent to the data aggregation server. This can allow the advertisement content network server 10 to identify the user in the future. Storing the identifier provided by the advertising content network server 10 is described in FIG. 2.

FIG. 1(B) is an alternate embodiment of the system described in FIG. 1(A). Rather than having a behavior targeting decision server determine when to notify the advertising content network server 10 when a user 30 has satisfied a behavioral rule, it is possible to have the end user computer 30 itself notify the network 10. The embedded tag on a web page that is being displayed on the user computer 30 can further include instructions for the user computer to retrieve code from the data aggregation server. The code may instruct the browser on the user computer 30 to evaluate the behavioral targeting rules that have been stored in the session cookie 64. For example, a behavioral targeting rule may be set to notify the ad content network if an item is placed in the shopping cart and subsequently abandoned. The user may browse web pages and add items to their shopping cart. If the user decides to abandon their purchase, code sent to the user's computer through the web page for abandoning a purchase may instruct the user's web browser to look at the session cookie, and determine if any rules have been satisfied. In the case that a rule has been satisfied, the end user computer 30 can send a notification to the advertising content network server 10. In many situations it is unnecessary to refer to historical profile data, as only information regarding the current browsing session is desired.

In addition to the embodiments of the invention as described in FIGS. 1(A) and 1(B), yet another alternate embodiment of the invention can comprise an approach that is a hybrid of the previously mentioned embodiments. In a hybrid embodiment, some of the behavioral targeting rules may be evaluated on the end user computer 30 and some of the behavioral targeting rules may be evaluated on the behavioral targeting decision server 80. In a hybrid environment, behavioral targeting rules requiring evaluation of historical data may be processed on the behavioral targeting decision servers, while those that do not require historical data may be processed on the end user computer.

FIG. 2 is a block diagram illustrating an exemplary embodiment of advertisement content network user identification exchange of the present invention. An advertisement content network server 210 requires a mechanism to identify a user 230 that has satisfied a behavioral targeting criteria, so that when the user 230 visits a site containing content provided by the advertisement content network server 210, an appropriate targeted ad can be delivered. As is well known in the art, the typical method for identifying a visitor to a web site is by the use of a cookie. Upon any access to a web server 240, the browser on a user's computer 230 will send to the web server 240 any cookies that have been written to the user's computer by that web server 240. Cookies written by other web servers however can not be sent to the currently visited web server. A mechanism for such an identity exchange is described in FIG. 2.

As has been previously discussed, the data aggregation server can place one or more cookies on the user computer 230. One of these cookies may be a session cookie 264. The session cookie 264 can contain data to be stored on the user computer 230. As was explained previously, in one potential embodiment, the session cookie 264 can contain one or more behavioral targeting rules. The embedded code contained on the web site 240 has access to read and write to data stored in the session cookie 264. In one embodiment, the embedded code can send a request to an advertising content network server 210 requesting an identifier that the advertising content network server 210 wishes to associate with a particular user 230. This request can be sent as a parameter attached to an HTTP request from the embedded code running on the user's computer 230 to the advertising content network server 210. The advertising content network server 210 can choose an identifier to designate this user 230. The advertising content network server 210 can return this identifier to the embedded code on the user computer 230 as a parameter attached to the HTTP response. The embedded code can then store this identifier in the session cookie 264. In addition, because the request to the advertising content network server 210 server was made through an HTTP request, the advertising content network server 210 may now set its own cookie 266 on the user computer 230. The advertising content network cookie 266 may contain the identifier that was assigned by the advertising content network server 210 and stored in the session cookie 264.

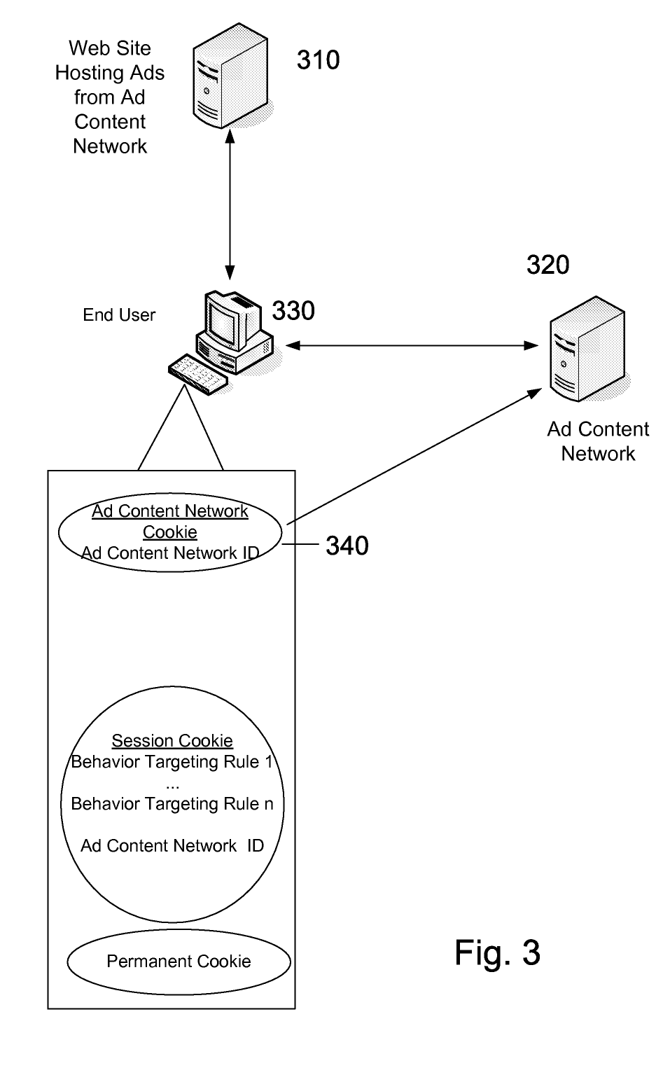

When a criteria set in a behavioral targeting rule is satisfied, the advertising content network server 210 can be notified through one of the mechanisms that has been previously described. This notification may contain the advertising content network identifier that was previously stored by the embedded code into the session cookie 264. The advertising content network server 210 can then be aware that the user who has been assigned a specific identifier has satisfied a behavioral targeting rule. In addition, the advertising content network server 210 can coordinate this identifier with the cookie 266 that was previously set. When the user visits a web site that contains ad content provided by the advertising content network server 210, the cookie 266 that was set by the advertising content network server 210 will be sent. This operation is described in FIG. 3.

FIG. 3 is a block diagram illustrating how an advertising content network server 320 can use the system as described above to deliver a targeted advertisement to a user 330. An end user 330 may visit a web site 310 that hosts advertisements from an advertising content network server 320. Part of the web page that is sent from the web site 310 to the end user 330 may include instructions to retrieve an advertisement to display from the advertising content network server 320. The end user computer 330 may then contact the advertisement content network server 320 to retrieve an advertisement to display. As part of the request to retrieve an advertisement, the end user computer 330 may include the cookie 340 that was previously set by the advertisement content network server 320 as described in FIG. 2.

Upon receipt of the request for an advertisement from the end user 330, the advertisement content network 320 can check the request to determine if a cookie 340 that was previously set is present. If a cookie 340 set by the advertisement content network server 320 is present, the network 320 can determine a user identifier from that cookie 340. The advertisement content network 320 can then determine if it has received any notifications for an end user 330 that has satisfied a behavioral targeting rule that corresponds to this identifier. If so, this information can be used by the advertising content network server 320 to provide an ad targeted to the end user 330. By examining the behavioral targeting rule that has been satisfied, the advertising content network server 320 will have information regarding the end user 330, and the end user's recent or historical internet behavior. This information can be used to provide an advertisement with the greatest chance of being relevant to the end user 330, and as such, the greater chance the end user 330 will click on the advertisement.

System in Operation

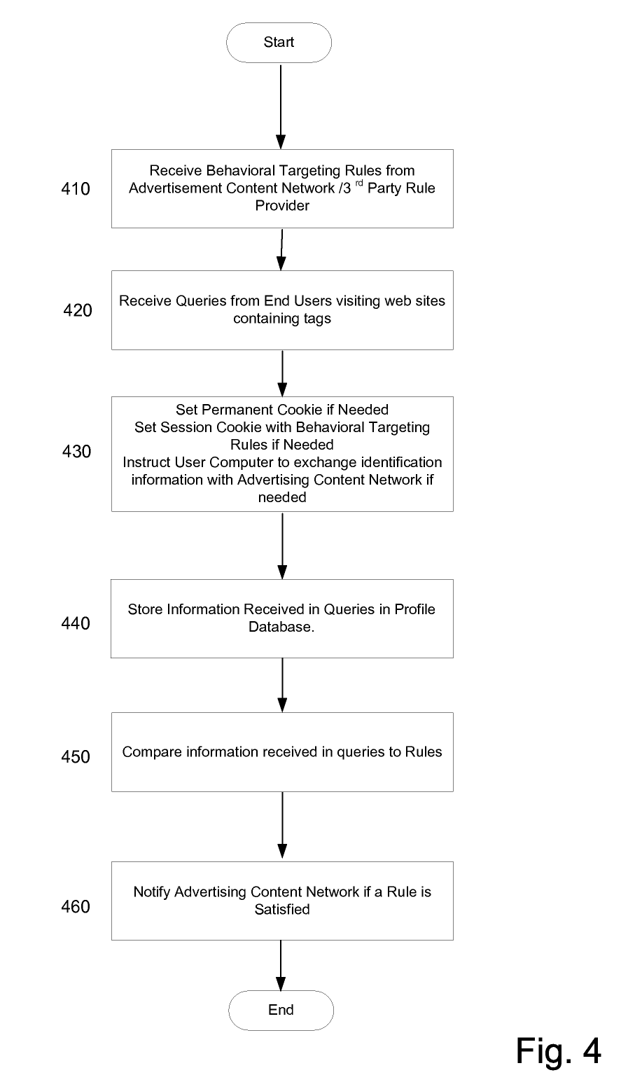

FIG. 4 is a flow chart the describes the operation of the broadcast system for personalized content. Although operation of the system is presented with no requirements for user input, various embodiments of the invention may allow a user to opt-out of participation in the system. A user may choose to opt-out for any number of reasons, such as privacy concerns. Furthermore, various embodiments of the invention may allow a user to opt-out of the system with various degrees of granularity. For example, a user may allow data regarding his web browsing activity to be logged, but will not allow any information identifying him as an individual to be created or maintained. As another example, a user may opt-out of receiving advertisements targeted to his individual internet behavior, but will allow advertisements based on the collective behavior of similarly situated web users. Embodiments of the invention can allow for an opt-in or opt-out functionality based on any number of user specified criteria.

The process may begin at step 410 where the advertising content network may create one or more behavioral targeting rules which define when the advertising content network should be notified of an internet user's activities. Examples of such rules may include notifying the advertising content network when a user visits a particular web site, when the user browses for a certain product, when the user visits a certain type of web site more than a certain number of times within a specified time period, or the like. Any information that would be beneficial to the advertising content network regarding an internet user's behavior may be formulated into a rule and sent to a behavioral targeting rules database.

At step 420 an end user may visit any number of web sites provided by any number of web site owners. Some of these web sites may contain embedded code, such as Javascript, that can be referred to as tags. These tags can instruct the end users computer to send information about the user, such as permanent cookies and session cookies, to a web analytics system. The end user's computers can also be instructed to send information about the web page that is currently being viewed to the web analytics system. Examples of information about the currently viewed web page can include what products or services are being sold on the web site, the owner of the web site, or any other information that would allow the web analytics server to monitor the web usage behavior of the end user.

At step 430, the queries received from the end user can be examined to determine if a permanent cookie identifying the user exists on the user computer. In the event that it does not exist, the web analytics server can create a new unique identifier for this user and store the identifier in a permanent cookie on the user's computer. In addition, the web analytics server can examine the received queries to determine if a session cookie is present. A session cookie can be used as an indicator to group the end users activities. There are many ways to define the length of a session. One example may be the length of a fixed period of time, such as a single day. Another example may be once a session is started, it remains in effect until the user is idle for a period of time. The session cookie can be used by the web analytics system to determine the browsing behavior of a user during any one given browsing session. In conjunction with the permanent cookie, an internet user's activities across many different sessions may be tracked.

If a session cookie does not exist, or is out of date, the web analytics server can set a new session cookie on the user's computer. This session cookie can contain data about when the cookie will expire. In addition, the cookie may also contain one or more behavioral targeting rules that were previously defined by the advertising content network. The web analytics system can also instruct the user computer to exchange identification information with the advertisement content network. For example, the user computer can be instructed to request an identifier from the advertisement content network. The advertisement content network can use this request as a opportunity to set its own identification cookie on the user's computer. The user's computer can also store this identifier in the session cookie.

At step 440, the web analytics system may store the information received in the queries to a profile database. The data can be stored including the permanent cookie information and the session cookie information. Storing this data allows the web analytics server to analyze an individual's web usage behavior in a single session, as well as across multiple web sessions. The data for an individual user can be combined with data for all other users to determine patterns of use for the individual user, as well as the pattern of use for all users.

At step 450, the information received in the queries can be compared with the behavioral targeting rules that were previously set by the advertisement content network. For some rules, such as a rule that requests notification upon the third visit of a user to a given web site within a month, the web analytics server may also refer to the information stored in the profile database to determine the user's past behavior. In an alternative embodiment, rather than evaluate the rules at the web analytics server, the tags received by the user computer can instruct the user computer to evaluate the rules as they have been set in the session cookie.

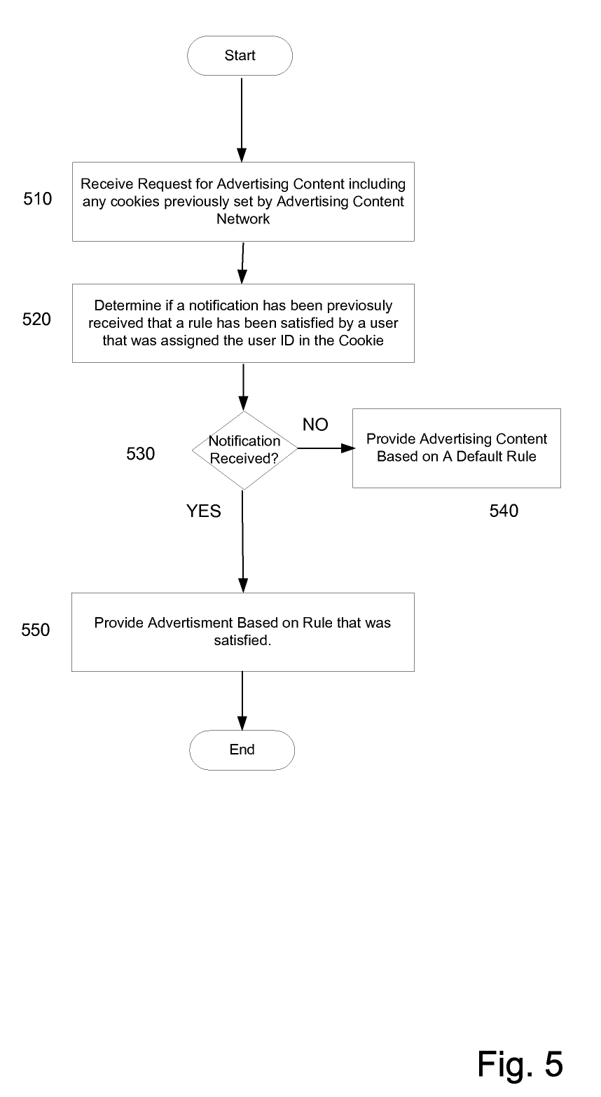

At step 460, if a rule has been satisfied, the advertising content network can be notified by sending a message to it. The message can include which behavioral targeting rule has been satisfied. The message can further include the identifier that was previously generated by the advertising content network in step 430 and stored in the session cookie. This identifier can allow the advertising content network to later recognize a user that has satisfied a behavioral targeting rule, as will be explained with respect to FIG. 5.

FIG. 5 is a flow chart that describes the operation of the advertisement content network using a behavioral targeting rule to deliver a targeted advertisement to a user. The process begins when a user visits a web site that offers advertising content that is being provided by the advertising content network. The web site can instruct the user's computer to contact the advertisement content network server to retrieve advertising content. This request can be received by the advertising content network at step 510. The request for advertising content will also include any cookies that have been set on the user computer by the advertisement content network.

At step 520, the advertisement content network can examine the cookie, if any, that it had previously set on the user's computer. The cookie can be examined to extract an identifier used by the advertisement content network to identify this user. This identifier can be compared with the notifications that the advertisement content network has received from the web analytics system at step 530. If no match is found, the advertisement content network can deliver an ad based on some default criteria at step 540.

If a match is found, the advertisement content network can determine which rule or rules have been satisfied by this user. At step 550, the advertisement content network can provide an advertisement to the user based on the one or more rules that have been satisfied.

Elements of System

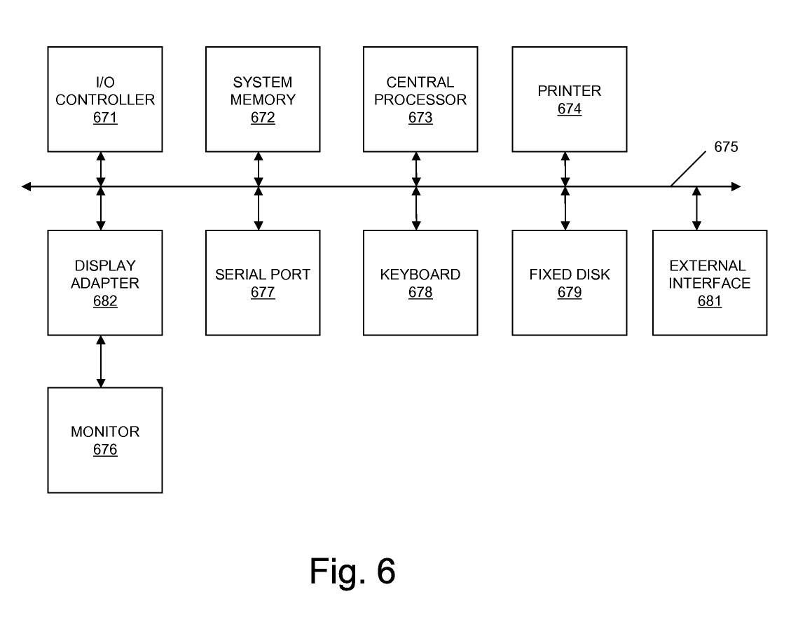

The various participants and elements in described may operate or use one or more computer apparatuses to facilitate the functions described herein. Any of the elements may use any suitable number of subsystems to facilitate the functions described herein. Examples of such subsystems or components are shown in FIG. 6. The subsystems shown in FIG. 6 are interconnected via a system bus 675. Additional subsystems such as a printer 674, keyboard 678, fixed disk 679 (or other memory comprising computer readable media), monitor 676, which is coupled to display adapter 682, and others are shown. Peripherals and input/output (I/O) devices, which couple to I/O controller 671, can be connected to the computer system by any number of means known in the art, such as serial port 677. For example, serial port 677 or external interface 681 can be used to connect the computer apparatus to a wide area network such as the Internet, a mouse input device, or a scanner. The interconnection via system bus allows the central processor 673 to communicate with each subsystem and to control the execution of instructions from system memory 672 or the fixed disk 679, as well as the exchange of information between subsystems. The system memory 672 and/or the fixed disk 679 may embody a computer readable medium. The computer readable medium may contain computer code to implement methods of the present invention.

The above description is only an example of a computer apparatus to facilitate the functions of the present invention. Any other suitable apparatus may also be used in embodiments of the present invention. Examples of other types of suitable apparatus include Cell Phones, Personal Digital Assistants (PDA), desktop computers, lap top computers, internet enabled televisions, and the like. Any device that allows a user to access the internet would be suitable for use in embodiments of the present invention. Furthermore, communications between the various elements of the present invention have been described with respect to the Internet. Any other type of communications media, such as local and wide area networks, public and private networks, and wired and wireless networks may also be used in embodiments of the present application.

Although exemplary embodiments of the present invention have recited a single user and a single advertising content network, it would be clear to a person of skill in the art that the invention may be used to service any number of end users or advertising content networks.

A recitation of “a”, “an” or “the” is intended to mean “one or more” unless specifically indicated to the contrary.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method of notifying an advertising content network of an internet user that has satisfied a behavioral targeting rule comprising:
receiving at least one behavioral targeting rule from an advertising content network;
embedding computer code on at least one web page of a web site to direct an end user's internet access device that is loading the at least one web page to send a query;
receiving the query;
storing a session cookie;
embedding computer code on the at least one web page of the client web site to direct the end user's internet access device to request an advertising content network identifier from the advertising content network;
comparing the query to the at least one behavioral targeting rule; and
sending a notification to the advertising content network.

2. The method of claim 1 wherein the at least one behavioral targeting rule indicates conditions to be satisfied prior to notifying the advertising content network.

3. The method of claim 1 wherein the query contains information identifying the at least one web page.

4. The method of claim 3 wherein the information identifying the at least one web page is stored in a profile database.

5. The method of claim 1 wherein the session cookie contains a session identifier and the at least one behavioral targeting rule and is stored on the end user's internet access device.

6. The method of claim 5 wherein the advertising content network identifier is stored in the session cookie.

7. The method of claim 3 wherein the information identifying the at least one web page is compared with the at least one behavioral targeting rule to determine if the at least one behavioral targeting rule has been satisfied.

8. The method of claim 7 wherein the notification includes the advertising content network identifier.

9. The method of claim 8 wherein the notification includes an indication that the at least one behavioral targeting rule has been satisfied.

10. A method of notifying an advertising content network of an internet user that has satisfied a behavioral targeting rule comprising:
receiving at least one behavioral targeting rule from an advertising content network indicating conditions to be satisfied prior to notifying the advertising content network;
embedding computer code on at least one web page of a client web site to direct an end user's internet access device that is loading the at least one web page to send a query containing information identifying the at least one web page;
receiving the query containing the information identifying the at least one web page being visited by the end user's internet access device and storing the information identifying the at least one web page in a profile database;
storing a session cookie containing a session identifier and the at least one behavioral targeting rule on the end user's internet access device;
embedding computer code on the at least one web page of the client web site to direct the end user's internet access device to request an advertising content network identifier from the advertising content network and to store the advertising content network identifier in the session cookie;
comparing the information identifying the at least one web page to the at least one behavioral targeting rule to determine if the at least one behavioral targeting rule has been satisfied; and
sending a notification to the advertising content network that includes the advertising content network identifier stored in the session cookie and an indication that the at least one behavioral targeting rule has been satisfied.

11. A system for notifying an advertising content network of an internet user that has satisfied a behavioral targeting rule comprising:
a behavioral targeting rules database configured to receive at least one behavioral targeting rule;
a data aggregation server configured to:
receive a query containing identification information for a web page;
store a session cookie containing a session identifier and the at least one behavioral targeting rule;
store the identification information for the web page and the session identifier into a profile database; and
receive the session cookie and extract an identifier provided by an advertising content network;
a behavior targeting decision server configured to:
compare the identification information for the web page to the at least one behavioral targeting rule; and
send a notification to the advertising content network.

12. The system of claim 11 wherein the at least one behavioral targeting rule is received from an advertisement content network.

13. The system of claim 12 wherein the at least one behavioral targeting rule is received through a user interface or an application programming interface.

14. The system of claim 11 wherein the query containing identification information for a web page is received from an end user's internet access device.

15. The system of claim 14 wherein the query is generated by computer code embedded on the web page being loaded by the user's internet access device.

16. The system of claim 15 wherein the session cookie is stored on the end user's internet access device.

17. The system of claim 11 wherein the identification information for the web page is compared to the at least one behavioral targeting rule to determine if the at least one behavioral targeting ruled has been satisfied.

18. The system of claim 17 wherein the notification includes the identifier provided by the advertising content network.

19. The system of claim 18 wherein the notification further includes an indication that the at least one behavioral targeting rule has been satisfied.

20. A system for notifying an advertising content network of an internet user that has satisfied a behavioral targeting rule comprising:
a behavioral targeting rules database configured to receive from an advertisement content network at least one behavioral targeting rule, the rule being received through a user interface or an application programming interface;
a data aggregation server configured to:
receive from an end user's internet access device a query containing identification information for a web page currently being loaded by the end user's internet access device, the query being generated by computer code embedded on the web page being loaded by the user's internet access device;
store a session cookie containing a session identifier and the at least one behavioral targeting rule on the end user's internet access device;
store the identification information for the web page currently being loaded and the session identifier into a profile database; and
receive the session cookie from the end user's internet access device and extract an identifier provided by an advertising content network;
a behavior targeting decision server configured to:
compare the identification information for the web page currently being loaded to the at least one behavioral targeting rule to determine if the at least one behavioral targeting ruled has been satisfied; and
send a notification to the advertising content network, the notification including the identifier provided by the advertising content network and an indication that the at least one behavioral targeting rule has been satisfied.
